(19) United States
(12) Patent Application Publication
(10) Pub. No.: US 2026/0085563 A1
(43) Pub. Date: Mar. 26, 2026

(54) HATCH MECHANISM

(71) Applicant: Gatemaster Ltd, Bognor Regis (GB)

(72) Inventor: Simon Garth Napthine, Eastergate (GB)

(21) Appl. No.: 19/333,790

(22) Filed: Sep. 19, 2025

(30) Foreign Application Priority Data
Sep. 20, 2024 (EP) 24201615.2
Mar. 27, 2025 (EP) 25166719.2

(51) Int. Cl. E05F 11/22

(52) U.S. Cl. CPC E05F 11/22; E05Y 2201/266; E05Y 2201/71; E05Y 2900/13

(57) ABSTRACT

A hatch assembly is provided, the assembly comprising a hatch lid connected via a connecting bar to an actuation means, such that opening and closing of the hatch lid by a user can be actuated at a location different from that of the hatch lid.

### CROSS REFERENCE TO RELATED APPLICATIONS

This application claims the benefit of priority to EP Application No. 24201615.2, filed Sep. 20, 2024 and EP Application No. 25166719.2 filed Mar. 27, 2025, the entire contents of each of which are incorporated herein by reference.

### INTRODUCTION

The present invention relates to a hatch assembly, with use in an offshore setting.

### BACKGROUND TO THE INVENTION

The extreme weather conditions associated with offshore settings usually mean traditional onshore hardware is unsuitable or poses a danger to the user when in use.

In an offshore setting, hardware is exposed to strong lateral forces from wind and rain. Furthermore, these weather conditions can result in frequent and unintended opening and closing of e.g., hatch lids, in the absence of user actuation.

A hatch is an access panel set into the floor of a structure, providing entry to a space below, such as a basement, cargo hold or maintenance area. It is typically covered by a hinged or removable lid.

Offshore structures typically comprise more than one level, with either staircases or ladders allowing users to move between these levels/platforms. Where ladders are used, the platforms typically have openings large enough to allow the user to pass through when ascending or descending the ladder. When not in use, these openings represent a danger to platform users. As such, hatches are typically used to cover the openings. These hatches can be opened by lifting or pushing the lid up and then closed by pulling or pushing the lid down.

Hatches known in the art tend to lack user friendliness and, in some cases, represent a danger to the user. This is because the user must stretch their position (whilst on the ladder) to actuate the hatch lid, e.g., by reaching down and pulling it up when descending a ladder. Furthermore, in offshore settings, where wind speeds are often very high, the hatch lid can be inadvertently forced towards the closed position (causing it to slam shut), which is a dangerous circumstance in instances where the user is passing through the hatch.

An aim of the present invention is to provide an alternative hatch mechanism which overcomes one or more of the aforementioned problems. An aim of a particular embodiment is to provide a robust hatch mechanism that may be transported as a single piece for easy fitting at the intended destination.

### BRIEF DESCRIPTION OF THE DRAWINGS

FIG. 1 is a perspective view of a hatch according to a preferred embodiment of the invention, with a cut-away portion exposing the internal workings of the mechanism;

FIGS. 2A and 2B show a hatch mechanism according to a preferred embodiment of the invention, wherein the hatch is shown in the closed position (A) and the open position (B);

FIG. 3 shows a close-up view of a hatch mechanism according to a preferred embodiment of the invention, with part of the mechanism housed behind a covering;

FIG. 4 shows the same view as in FIG. 3 with the covering removed to expose the otherwise housed part of the mechanism; and

FIG. 5 shows a close-up view of a hatch mechanism according to a preferred embodiment of the invention, with an inward-facing panel removed to expose the internal workings of the mechanism.

### SUMMARY OF THE INVENTION

The invention provides a hatch assembly that mitigates one or more of the aforementioned risks that traditional hatch assemblies pose to users.

Hatch assemblies according to the invention are preferably floor-mounted.

In a first embodiment, the invention provides a hatch assembly comprising a hatch lid connected via a connecting bar to a first actuation means which, in turn, is connected to a second actuation means via a connecting rod. Actuation of either actuation means results in movement of the hatch lid between open and closed positions.

Preferably, the hatch assembly comprises the following components:
a hatch lid;
a connecting bar connected to the hatch lid;
a first actuation means connected to the connecting bar at an opposite end to that of the hatch lid; and
a connecting rod, wherein the connecting rod connects the first actuation means with a second actuation means at an opposite end of the connecting rod,
   such that actuation of either the first or second actuation means results in movement of the hatch lid between open and closed positions.

The connecting bar connects the first actuation means with the hatch lid, preferably with each being attached at opposite ends of the connecting bar, forming two pivot points. The pivot point formed from connecting the hatch lid to the connecting bar allows for the hatch lid to pivot between open and closed positions. In the open position, a user can pass through an opening created in the hatch assembly, whilst in the closed position this opening is not present. The pivot point formed from connecting the first actuation means to the connecting bar allows for the actuation means (e.g., handle) to pivot between at least two positions: one wherein the hatch lid is open and one wherein the hatch lid is closed.

Accordingly, actuation of the hatch mechanism moves the connecting bar, such that the hatch lid pivots about its pivot point, thereby moving it between open and closed positions. The connecting bar is preferably substantially straight. More preferably, the connecting bar comprises substantially symmetrical inclined planes at either end, meeting at a central straight portion. It is preferred that the distal ends of the connecting bar (e.g., bottom of each incline plane) comprise the pivot point for the first actuation means and the hatch lid, respectively.

Preferably, the hatch assembly comprises a biasing means, such that movement of the hatch lid into the open position is assisted (i.e., with bias), whilst movement of the hatch lid into the closed position is resisted/slowed (i.e., against bias). This is particularly advantageous, since hatch lids can be heavy components which are otherwise difficult for a user to open and can dangerously and inadvertently slam shut with significant force (e.g., from wind). When the biasing means is resisting movement (i.e., against bias), the biasing means may otherwise be referred to as a resisting means.

The biasing means is positioned such that upon actuation of the mechanism, movement of the hatch lid is either assisted or resisted. Accordingly, the biasing means may be attached to the connecting rod or the connecting bar, in a way that provides the least obstruction to a user passing through the hatch opening. For space-saving purposes, when connected to the connecting bar, it is preferred to have the majority of the biasing means sit below the substantially straight portion of the connecting bar.

The biasing means may comprise one or more springs. In some cases, it is preferred that two or more springs are used. Preferably, three springs are used. By way of example, a hatch lid with a weight of approximately 20 kg or less may be most suitably assisted by a single spring. Hatch lids weighing over 20 kg are most suitably assisted by two or more springs. In this situation, it has been found that using two or more smaller springs is preferable to using one larger spring. This is because a single spring requires a greater diameter to achieve the same tension/resistance as that of two or more adjacently placed smaller springs. In the context of hatch assemblies, where the openings are typically small, it is beneficial to keep the hatch mechanism as space efficient as possible, so as to maximize the space available for a user to pass through the opening.

In a particularly preferred embodiment, the biasing means makes use of extension springs. Use of constant-force springs is less preferred.

The biasing means, moving with bias, is particularly useful in situations where the required hatch lid is heavy and would thus otherwise represent a difficulty for the user to open.

The connecting rod connects the first actuation means with the second actuation means, preferably with each being attached at opposite ends of the connecting rod, forming two pivot points. It is preferred that one of the first and second actuation means is connected to the connecting rod via a cam or similar. Most preferably, the first actuation means is connected to the connecting rod via the cam. The connecting rod thus acts as a follower. For example, in the case that the actuation means is a handle, the cam acts to convert the rotary motion of the handle to linear motion of the connecting rod.

In use, it is preferred that the connecting rod is substantially vertically disposed, so as to place the first actuation means at a lower position than the second actuation means. It is preferred that movement of the first actuation means from a first position (wherein the hatch lid is closed) to a second position (wherein the hatch lid is open) results in movement of the second actuation means from a first position (wherein the hatch lid is closed) to a second position (wherein the hatch lid is open) and vice versa.

The first and second actuation means are preferably located on opposite sides of the hatch lid, such that the first actuation means is operable when the user approaches from below the assembly and the second actuation means is operable when the user approaches from above the assembly.

Whilst any mechanism capable of moving the connecting rod and connecting bar between positions is suitable as the actuation means, the first and/or second actuation means may be in the form of a mechanical handle. When one handle is actuated, the second handle also moves position via movement of the connecting rod.

The invention provides use of the hatch assembly, as defined above and below, for fitting to an offshore structure. The offshore structure may be bottom supported/fixed or floating.

Optionally, the bottom supported/fixed offshore structure is a jack-up rig, a gravity-based platform, a compliant tower, a monopile structure, a bridge platform, a junction platform, or a jacket platform.

Optionally, the floating offshore structure is a drilling barge, a semi-submersible rig, a drillship, a spar platform, a tension leg platform, or a floating, production, storage and offloading (FPSO) system.

The hatch assembly of the invention is particularly advantageous in this offshore setting, where platform space is often limited, and environmental forces are often strong.

Even when the hatch assembly is fitted to a platform that is indoors, in offshore settings the assembly will be exposed to high levels of salt water, which can corrode the components. For this reason, it is preferred that the assembly is made from materials that resist corrosion. Preferably, aluminium and/or stainless steel (high-grade) is used to construct the assembly.

The invention provides a method of using the hatch assembly as defined above and below, wherein
upon approaching the hatch assembly from the underside (e.g., when ascending a ladder or similar) the user actuates the first actuation means, so as to move the hatch lid into the open position;
the user then passes through the opening formed by the open hatch lid, so as to arrive at an opposite side of the hatch assembly; and
the user actuates the second actuation means, so as to move the hatch lid back into the closed position.

The invention also provides a method of using the hatch assembly as defined above and below, wherein
upon approaching the hatch assembly from the upper side (e.g., from a platform or when descending a ladder or similar) the user actuates the second actuation means, so as to move the hatch lid into the open position;
the user then passes through the opening formed by the open hatch lid, so as to arrive at an opposite side of the hatch assembly; and
the user actuates the first actuation means, so as to move the hatch lid back into the closed position.

Advantageously, the hatch assembly comprises the actuation means (e.g., handles) towards the top and the bottom of the assembly (i.e., above and below the hatch lid). This is particularly helpful in increasing the user friendliness of the device, ensuring the user decreases injury risk when operating the hatch.

Accordingly, it is preferred that the actuation means (e.g., handles) are located toward the ladder (in use). This allows the user to actuate the mechanism from above or below the hatch lid, with minimal danger, since there is no need for the user to push or pull the hatch lid directly. Preferably, the second actuation means is located at a suitable distance above the hatch lid that the user can fully pass through the opening in the hatch before comfortably actuating the mechanism to move the lid back into the closed position. It is preferred that the second actuation means is located approximately 120-180 cm above the top of the hatch lid in the closed position. More preferably, the second actuation means is located approximately 140-160 cm above the top of the hatch lid in the closed position.

As set out elsewhere herein, the invention provides the following embodiments:
1. A hatch assembly comprising the following components:
   a hatch lid;
   a connecting bar connected to the hatch lid;
   a first actuation means connected to the connecting bar at an opposite end to that of the hatch lid; and
   a connecting rod, wherein the connecting rod connects the first actuation means with a second actuation means at an opposite end of the connecting rod,
   such that actuation of either the first or second actuation means results in movement of the hatch lid between open and closed positions.
2. A hatch assembly according to embodiment 1, comprising a biasing means, such that movement of the hatch lid into the open position is assisted (with bias), whilst movement of the hatch lid into the closed position is resisted/slowed (against bias).
3. A hatch assembly according to embodiment 2, wherein the biasing means is attached to the connecting rod.
4. A hatch assembly according to embodiment 2 or 3, wherein the biasing means comprises one or more springs.
5. A hatch assembly according to any of embodiments 2-4, wherein the biasing means comprises at least two extension springs.
6. A hatch assembly according to any preceding embodiment, wherein the first and/or second actuation means comprise a mechanical handle.
7. A hatch assembly according to any preceding embodiment, wherein the first and second actuation means are located on opposite sides of the hatch lid when in the closed position.
8. A hatch assembly according to any preceding embodiment, wherein movement of the first actuation means from a first position (wherein the hatch lid is closed) to a second position (wherein the hatch lid is open) results in movement of the second actuation means from a first position (wherein the hatch lid is closed) to a second position (wherein the hatch lid is open) and vice versa.
9. Use of the hatch assembly as defined in any preceding embodiment, wherein the hatch assembly is fitted to an offshore structure, optionally wherein the offshore structure is bottom supported/fixed or floating.
10. Use according to embodiment 9, wherein the fixed offshore structure is a jack-up rig, a gravity-based platform, a compliant tower, a monopile structure, a bridge platform, a junction platform, or a jacket platform.
11. Use according to embodiment 9, wherein the floating offshore structure is a drilling barge, a semi-submersible rig, a drillship, a spar platform, a tension leg platform, or a floating, production, storage and offloading (FPSO) system.
12. A method of using the hatch assembly as defined in any of embodiments 1-8, wherein
   upon approaching the hatch assembly from the underside (e.g., when ascending a ladder or similar) the user actuates the first actuation means, so as to move the hatch lid into the open position;
   the user then passes through the opening formed by the open hatch lid, so as to arrive at an opposite side of the hatch assembly; and
   the user actuates the second actuation means, so as to move the hatch lid back into the closed position.
13. A method of using the hatch assembly as defined in any of embodiments 1-8, wherein
   upon approaching the hatch assembly from the upper side (e.g., from a platform or when descending a ladder or similar) the user actuates the second actuation means, so as to move the hatch lid into the open position;
   the user then passes through the opening formed by the open hatch lid, so as to arrive at an opposite side of the hatch assembly; and
   the user actuates the first actuation means, so as to move the hatch lid back into the closed position.
14. A method according to embodiment 12 or embodiment 13, wherein the second actuation means is located approximately 120-180 cm above the top of the hatch lid in the closed position.
15. A hatch assembly according to any of embodiments 1-8, use according to any of embodiments 9-11 or a method according to any of embodiments 12-14, wherein the second actuation means is located approximately 140-160 cm above the top of the hatch lid in the closed position.

In another embodiment, the invention provides a hatch assembly comprising a hatch lid connected via a connecting bar to a lever arm, wherein the hatch assembly further comprises a resisting means, such that movement of the hatch lid into the closed position is resisted. This is particularly advantageous, since hatch lids can be heavy components which can dangerously and inadvertently slam shut with significant force (e.g., from wind).

Preferably, the hatch assembly comprises the following components:
a hatch lid;
a connecting bar connected to the hatch lid;
a lever arm connected to the connecting bar at an opposite end to that of the hatch lid; and
a resisting means configured to resist movement of the hatch lid from its open position to its closed position.

Preferably, the lever arm comprises a pedal/handle at its distal end (with its proximal end being defined according to its connection to the connecting bar). The pedal is preferably foot-operable. Optionally, the lever arm pivots about a substantially central pivot point, such that when a user stands on the pedal to open the hatch lid, the lever arm pivots, advancing its proximal end upwards, thereby opening the hatch lid (via the connecting bar).

The resisting means may be a rotary damper. Preferably, the rotary damper is unidirectional, so as not to resist movement of the hatch lid towards the open position. In this case, a gear portion may be provided on the lever arm, said gear portion comprising teeth that can interact with a mating gear portion on the rotary damper. Preferably, the gear portion is provided at the proximal end of the lever arm.

Optionally, a biasing means is also present to assist movement of the hatch lid into the open position (i.e., with bias). This is advantageous, since hatch lids can be heavy components which are otherwise difficult for a user to open. In this case, the resisting means and the biasing means are optionally the same (and may elsewhere herein simply be referred to as “biasing means”).

The biasing means may be a spring. This is advantageous when it is required to both resist movement of the hatch lid into the closed position (against bias) and assist movement of the hatch lid into the open position (with bias). Preferably, the spring is a coiled spring. Preferably, the spring is provided at the proximal end of the lever arm.

The connecting bar connects the lever arm with the hatch lid, preferably with each being attached at opposite ends of the connecting bar, forming two pivot points. The pivot point formed from connecting the hatch lid to the connecting bar allows for the hatch lid to pivot between open and closed positions. In the open position, a user can pass through an opening created in the hatch assembly, whilst in the closed position this opening is not present.

Accordingly, actuation of the hatch mechanism moves the connecting bar, such that the hatch lid pivots about its pivot point, thereby moving it between open and closed positions.

The invention provides use of the hatch assembly, as defined above and below, for fitting to an offshore structure. The offshore structure may be bottom supported/fixed or floating.

Optionally, the bottom supported/fixed offshore structure is a jack-up rig, a gravity-based platform, a compliant tower, a monopile structure, a bridge platform, a junction platform, or a jacket platform.

Optionally, the floating offshore structure is a drilling barge, a semi-submersible rig, a drillship, a spar platform, a tension leg platform, or a floating, production, storage and offloading (FPSO) system.

The hatch assembly of the invention is particularly advantageous in this offshore setting, where platform space is often limited, and environmental forces are often strong.

Even when the hatch assembly is fitted to a platform that is indoors, in offshore settings the assembly will be exposed to high levels of salt water, which can corrode the components. For this reason, it is preferred that the assembly is made from materials that resist corrosion. Preferably, aluminium and/or stainless steel (high-grade) is used to construct the assembly.

The invention also provides a method of using the hatch assembly as defined above and below, wherein
upon approaching the hatch assembly from the upper side (e.g., from a platform or when descending a ladder or similar) the user actuates the lever arm, so as to move the hatch lid into the open position;
the user then passes through the opening formed by the open hatch lid, so as to arrive at an opposite side of the hatch assembly; and
the user allows the hatch lid to move back into the closed position (e.g., under gravity).

Preferably, the user actuates the lever arm via a handle or pedal. Preferably, the pedal is foot-operable, such that a user can conveniently open the hatch lid from above (e.g., when descending a ladder towards the hatch lid).

Preferably, movement of the hatch lid back into the closed position requires no user actuation. The hatch lid may naturally return to the closed position, however it is preferred that movement from the open position to the closed position is resisted by a resisting means, such as a rotary damper. Preferably, the resisting means slows the closing of the hatch lid substantially, so as to provide adequate time for the user to pass through the hatch opening. As such, it is preferred that it takes at least 10 seconds for the hatch lid to move from the fully open position to the fully closed position, more preferably at least 15 seconds, most preferably at least 20 seconds.

The invention hence provides a hatch mechanism, with particular use in offshore settings.

### EXAMPLES

The invention is now illustrated in specific examples, with reference to the accompanying drawings, in which:

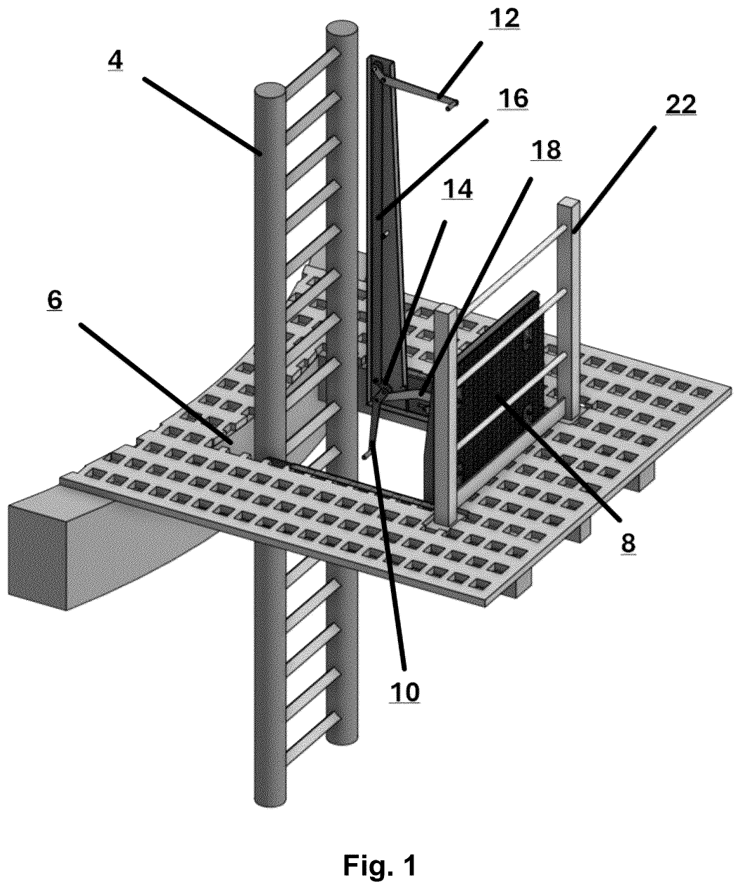

FIG. 1 is a perspective view of a hatch according to a preferred embodiment of the invention, with a cut-away portion exposing the internal workings of the mechanism;

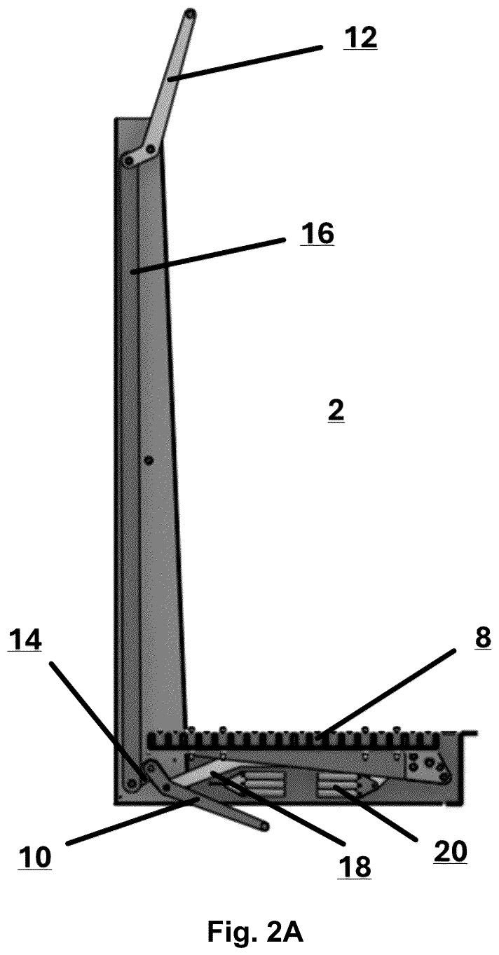

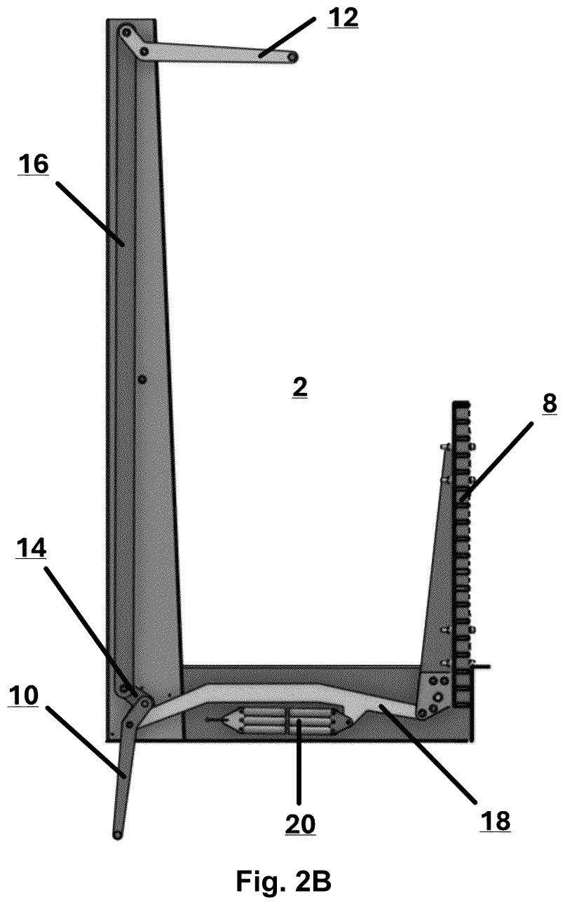

FIGS. 2A and 2B show a hatch mechanism according to a preferred embodiment of the invention, wherein the hatch is shown in the closed position (A) and the open position (B);

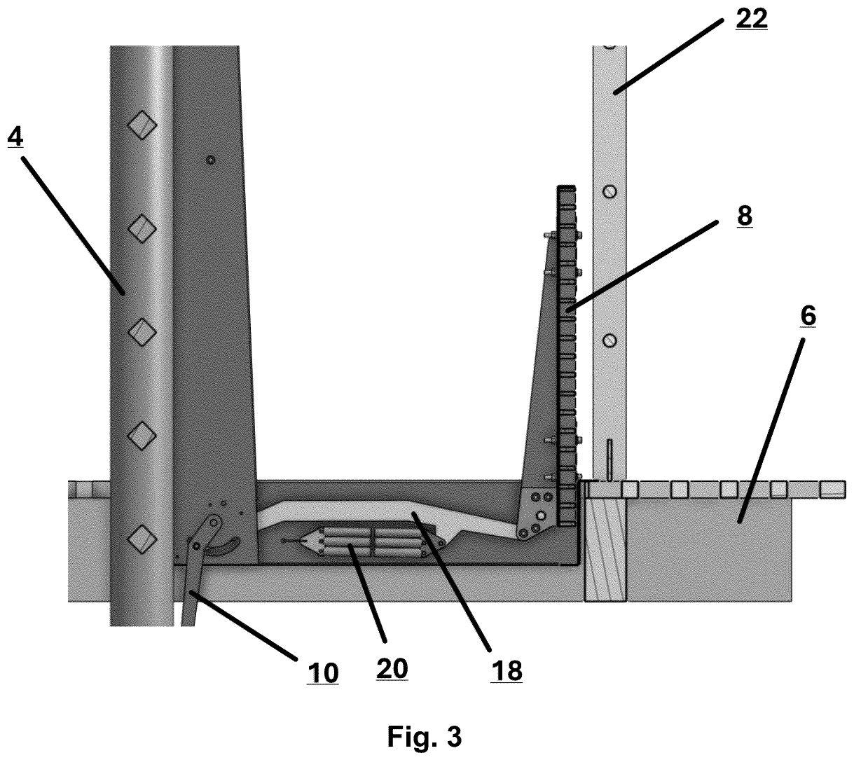

FIG. 3 shows a close-up view of a hatch mechanism according to a preferred embodiment of the invention, with part of the mechanism housed behind a covering;

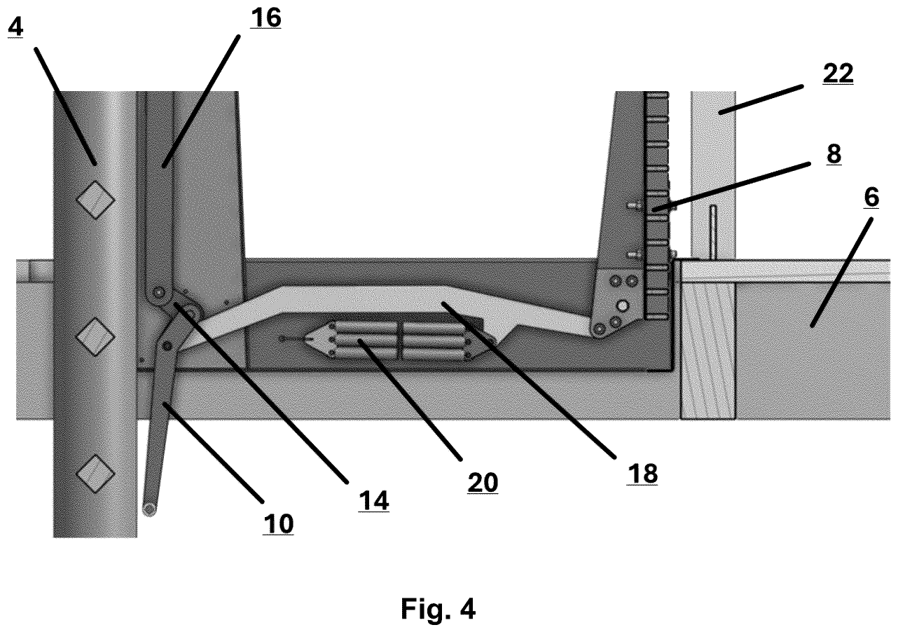

FIG. 4 shows the same view as in FIG. 3 with the covering removed to expose the otherwise housed part of the mechanism; and

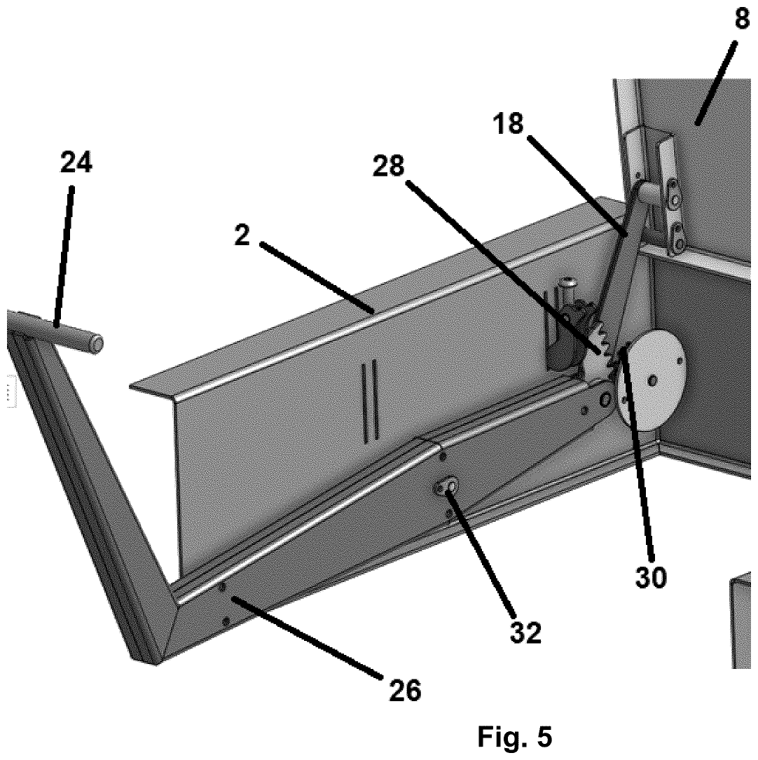

FIG. 5 shows a close-up view of a hatch mechanism according to a preferred embodiment of the invention, with an inward-facing panel removed to expose the internal workings of the mechanism.

### REFERENCE KEY

Hatch assembly (2)
Ladder (4)
Platform (6)
Hatch lid (8)
First (lower) handle (10)
Second (upper) handle (12)
Cam (14)
Connecting rod (16)
Connecting bar (18)
Spring biasing means (20)
Railing panel (22)
Foot pedal (24)
Lever arm (26)
Gear portion (28)
Rotary damper (30)
Lever arm pivot point (32)

### Example 1

As illustrated in FIGS. 1-4, there is provided a hatch assembly (2) fitted to an offshore platform (6).

Whilst not shown, this platform (6) is one of multiple stacked platforms, making up different levels of the offshore structure. These levels can be travelled between by a user using a ladder (4), wherein an opening in the platform(s) next to the ladder exists that is large enough to allow the user to pass through when ascending or descending the ladder.

It is within this opening in the platform (6) next to the ladder (4) that the hatch assembly (2) is fitted.

The hatch assembly (2) arrives in one-piece and can simply be bolted to the platform (6), at its edges around the opening, such that it is secured in place. This results in an upward-facing portion of the assembly running parallel with the ladder (4).

Within the upward-facing portion of the assembly (2), there exists a vertically disposed connecting rod (16) connected to a first handle (10) at its lower end and connected to a second handle (12) at its upper end. These connections form pivot points to allow rotary motion of the handles. As can be seen in FIG. 3, the connecting rod is housed behind a metal casing in use.

Rotary motion of either the first or second handle (10, 12) is converted into linear motion of the connecting rod (16), such that the three components move as one. When the first handle moves from a first position to a second position, so do the connecting rod and second handle, and vice versa.

Since the first handle (10) is connected to both the connecting rod (16) and the connecting bar (see description below), the first handle has two pivot points with respect to these components. To assist in ensuring a smooth linear motion of each of these two components, the first handle is connected to the connecting rod via a cam (14). The cam ensures that rotary motion of the first handle is converted into linear motion of the connecting rod.

The first handle (10) rests just below the hatch lid (8) when the hatch lid is closed, such that the user can actuate the handle easily when ascending the ladder (4) from below the hatch assembly (2).

The second handle (12) rests approximately at shoulder/chest height above the platform (6), such that the user can actuate the handle easily when approaching the hatch assembly (2) from the platform or when descending the ladder (4) from above the hatch assembly. When ascending the ladder through the opening in the hatch assembly, the user can easily close the hatch lid by actuating the second handle, without overstretching and without obstructing the closing hatch lid (8).

Mechanically, the hatch lid (8) is moved between open and closed positions upon actuation of either handle (10,12) because the first handle (10) is also pivotably connected to a connecting bar (18), and this connecting bar is further pivotably connected to the hatch lid at its opposite end.

Accordingly, when in the closed position and the user actuates either handle (10, 12) to open the hatch lid (8), rotary motion of the handle is converted to linear motion of the connecting bar (18) and, consequentially, pivoting of the hatch lid from a position in which it lies flat across the opening (closed position—see FIG. 2A) to a position in which it is raised up to expose the opening (open position—see FIG. 2B). The same is true in reverse, when the user wishes to close the hatch.

A set of three adjacently disposed extension springs (20) are provided on the underside of the connecting bar (18). At one end they are rigidly fixed to the assembly body, whilst at the other end they are connected to the connecting bar. Upon closing of the hatch lid (8), i.e., linear movement of the connecting bar toward the pivot point of the lid, the tightly wound helical coils of the springs elastically deform to absorb the tension of the load. This softens the closing of the lid. Upon opening of the hatch lid, i.e., linear movement of the connecting bar toward the pivot point of the first handle, the deformed helical coils of the springs return to their rested state (tightly wound), thus assisting the user in opening the lid.

To prevent accidental injury when operating the hatch assembly (2), a set of railings (22) is provided to discourage users approaching the assembly at the position the hatch lid (8) swings open.

### Example 2

As illustrated in FIG. 5, there is provided a hatch assembly (2).

Whilst not shown, the assembly is fitted to an offshore platform that is one of multiple stacked platforms, making up different levels of the offshore structure. These levels can be travelled between by a user using a ladder, wherein an opening in the platform(s) next to the ladder exists that is large enough to allow the user to pass through when ascending or descending the ladder.

It is within this opening in the platform next to the ladder that the hatch assembly (2) is fitted.

The hatch assembly (2) arrives in one-piece and can simply be bolted to the platform, at its edges around the opening, such that it is secured in place.

Upon approaching the hatch assembly (2), e.g., when descending a ladder, the user can actuate the mechanism using just one foot on the pedal (24). This advantageously allows the user to maintain three points of contact with the ladder, whilst opening the hatch lid (8).

The pedal (24) is on/connected to a distal end of a lever arm (26) that pivots about a central pivot point (32), so as to move a proximal end of the lever arm (26) vertically upwards.

The proximal end of the lever arm (26) is pivotally connected to a connecting bar (18) which, in turn, is pivotally connected to the hatch lid (8). As such, actuation of the foot pedal (24) opens the hatch lid (8).

The proximal end of the lever arm (26) also has a geared portion (28) that is configured to communicate with/engage with a mating gear on a rotary damper (30).

Once the user has passed through the hatch, the hatch lid (8) is able to automatically close under gravity. However, risk of injury to the user is mitigated via the rotary damper (30). This is because movement of the hatch lid (8) towards the closed position requires the connecting bar (18) to force the proximal end of the lever arm (26) vertically downwards, whilst this movement is being resisted by the rotary damper (30).

The rotary damper (30) is thus unidirectional and slows closing of the hatch lid in a controlled manner.

The invention hence provides a hatch mechanism, with particular use in offshore settings.

1. A hatch assembly (2) comprising:
a hatch lid (8);
a connecting bar (18) connected to the hatch lid;
a lever arm (26) connected to the connecting bar at an opposite end to that of the hatch lid; and
a resisting means (30) configured to resist movement of the hatch lid from its open position to its closed position.

2. The hatch assembly of claim 1, wherein the resisting means is unidirectional.

3. The hatch assembly of claim 2, wherein the resisting means does not resist movement of the hatch lid from its closed position to its open position.

4. The hatch assembly of claim 1, wherein the resisting means is a rotary damper.

5. The hatch assembly of claim 4, wherein the rotary damper is unidirectional.

6. The hatch assembly of claim 1, wherein the lever arm comprises a geared portion (28).

7. The hatch assembly of claim 6, wherein the resisting means comprises a mating geared portion.

8. The hatch assembly of claim 7, wherein teeth of the geared portion engage with teeth of the mating geared portion to resist movement of the hatch lid.

9. The hatch assembly of claim 1, further comprising a biasing means (20) configured to assist movement of the hatch lid into the open position.

10. The hatch assembly of claim 9, wherein the biasing means comprises one or more springs.

11. The hatch assembly of claim 10, wherein the one or more springs comprise coiled springs.

12. The hatch assembly of claim 9, wherein the biasing means comprises extension springs.

13. The hatch assembly of claim 1, further comprising an actuation means.

14. The hatch assembly of claim 13, wherein the actuation means comprises a mechanical handle.

15. The hatch assembly of claim 13, wherein the actuation means comprises a pedal (24).

16. The hatch assembly of claim 15, wherein the pedal is provided on the lever arm.

17. The hatch assembly of claim 16, wherein the pedal is foot-operable.

18. The hatch assembly of claim 1, wherein the hatch assembly is configured for installation on an offshore structure.

19. The hatch assembly of claim 18, wherein the offshore structure is selected from the group consisting of a jack-up rig, a gravity-based platform, a compliant tower, a monopile structure, a bridge platform, a junction platform, a jacket platform, a drilling barge, a semi-submersible rig, a drillship, a spar platform, a tension leg platform, and a floating, production, storage and offloading (FPSO) system.

20. A method of operating the hatch assembly of claim 1, the method comprising:
actuating the lever arm to move the hatch lid from a closed position to an open position;
passing through an opening formed by the open hatch lid; and
allowing the hatch lid to move back to the closed position under the influence of gravity, wherein movement of the hatch lid back to the closed position is resisted by the resisting means.
